(19) United States
(12) Patent Application Publication
(10) Pub. No.: US 2021/0048559 A1
(43) Pub. Date: Feb. 18, 2021

(54) Nanoparticles of Encapsulated Light-Absorbing Agent, Preparation Thereof and Ophthalmic Lens Comprising Said Nanoparticles

(71) Applicant: ESSILOR INTERNATIONAL, Charenton-le-Pont (FR)

(72) Inventors: Pierre FROMENTIN, Bangkok (TH); Tipparat LERTWATTANASERI, Bangkok (TH); Waranya PHOMPAN, Bangkok (TH)

(21) Appl. No.: 16/966,938

(22) PCT Filed: Feb. 9, 2018
(86) PCT No.: PCT/IB2018/000175

§ 371 Date: Aug. 3, 2020

(51) Int. Cl. G02B 1/04; G02B 5/22

(52) U.S. Cl. CPC G02B 1/043; G02B 5/223

(57) ABSTRACT

The invention relates to nanoparticles of a composite material comprising a light absorbing agent dispersed in a matrix of a mineral oxide, to a method for the preparation of such nanoparticles, to the use of said method to modify the hue of nanoparticles of composite material comprising a light absorbing agent, and to an ophthalmic lens comprising such nanoparticles.

### TECHNICAL FIELD

The present invention relates to the field of ophthalmic lenses. More particularly, the invention relates to nanoparticles of a composite material comprising a light absorbing agent dispersed in a matrix of a mineral oxide, to a method for the preparation of such nanoparticles, to the use of said method to modify the hue of nanoparticles of composite material comprising a light absorbing agent, and to an ophthalmic lens comprising such nanoparticles.

### BACKGROUND OF THE INVENTION

Plastic ophthalmic lenses are well known and have a common usage. Today there are two main categories of plastic lenses, the first wherein plastic represents a thermoplastic polymer, and the second wherein plastic represents a thermoset polymer resulting from the polymerization of a polymerizable composition comprising monomer and/or oligomer which are able to polymerize under activation to form a polymer. Among polymers used to manufacture plastic ophthalmic lenses, mention may be made in particular of polycarbonates such as for example allyl diglycol carbonate (also named CR-39). The use of these polymers leads to ophthalmic lenses having excellent properties in terms safety, cost and ease of production and optical quality. Although exhibiting such good properties, plastic ophthalmic lenses have often the drawback of being slightly colored, in particular yellow colored because the polymers used for their preparation are themselves slightly colored, in particular slightly yellow, which results in unaesthetic effects for the lens wearer.

One of the solutions known to suppress this unaesthetic color in ophthalmic lenses is the incorporation of colored molecules, in particular blue dyes, into the bulk liquid raw polymerizable formulation (i.e. before polymerization) used during the manufacturing process to balance the intrinsic and undesired colour of the polymers and get a final lens which is less colored or uncolored. However, the molecules used for this purpose are not always compatible with the bulk liquid raw polymerizable formulation and they might be degraded during the polymerization process.

Patents such as EP2282713, EP2263788 and JP3347140 describe UV absorbers encapsulated in mineral matrixes for cosmetic applications to provide protection against sunburns. However, the high amount of UV-absorbers contained in the nanoparticles and in the cosmetic composition is not compatible with a liquid polymerizable composition for the preparation of an ophthalmic lens. The technology used in these patents is therefore not directly transposable in the field of ophthalmic lenses.

In addition, if encapsulation can be a very attractive technology to compatibilize unstable molecules in a given polymer formulation, the encapsulation process may also lead to some changes in the dye spectral properties while comparing to standard dyes spectra in solution, because of possible interaction with the mineral matrixes or other factors. It results from these changes that it is not easy to predict which will be the spectral properties of the encapsulated dye and if the incorporation of such encapsulated dye into a bulk liquid polymerizable formulation will be convenient to balance the intrinsic undesired colour of the lens polymer matrix.

There is thus a need for coloured material that can be used during the manufacturing process of plastic ophthalmic lenses and the colour of which can be tuned to balance the intrinsic and undesired color of the lens polymers and get a final lens which is less colored or uncolored.

The Applicant has found that this need could be met by using nanoparticles encapsulating a light absorbing agent having the property of exhibiting different aggregation states.

### SUMMURY OF THE INVENTION

A first object of the present invention is therefore nanoparticles of a composite material comprising at least one light absorbing agent LA dispersed in a matrix of a mineral oxide, wherein:

the light absorbing agent LA is dispersed in said matrix in both a monomeric form LAₘ and an aggregated form LA_{A},

said light absorbing agent LA has an absorbance ratio A=A_{A}/A_{M} ranging from 1.25 to 10, where A_{A} is absorbance of LA measured at the wavelength of maximum absorption of LA_{A} and A_{M} is absorbance of LA measured at the wavelength of maximum absorption of LA_{M}.

A second object of the present invention is a method for the preparation of nanoparticles as defined according to the first object of the present invention, wherein said method comprises at least the following steps,

i) a step of preparing nanoparticles of a composite material comprising at least one light absorbing agent in a monomeric form LA_{M} dispersed in a matrix of a mineral oxide,

ii) a step of annealing the nanoparticles obtained in step i) at a temperature ranging from 80 to 300° C. for a period of time ranging from 5 min to 120 hours.

A third object of the present invention is the use of the method as defined according to the second object of the present invention, to modify the hue of nanoparticules of a composite material comprising at least one light absorbing agent LA dispersed in a matrix of a mineral oxide.

Finally, a forth object of the present invention is an ophthalmic lens comprising nanoparticles as defined according to the first object of the present invention.

Thanks to the present invention, the hue of the nanoparticles can be adjusted by varying the absorbance ratio A to obtain a color balancing agent which will lead to an ophthalmic lens with a residual colour as neutral as possible.

In particular, thanks to the annealing step of the method according to the invention, a single dye material encapsulated in a matrix of mineral oxide can thus lead to several hues within a given interval depending on the process condition, i.e. the temperature and duration of the annealing step, thus, enabling the use of the same basic material for different product applications. In particular, the annealing step is performed to modulate the aggregation levels of the light absorbing agents that are responsible for the final color of the nanoparticles.

Encapsulating the light-absorbing agent has also other advantages. Mineral particles are a good encapsulation material for water-soluble light-absorbing agent. Indeed, these particles present a good compatibility with aprotic mediums such as monomer. Surface modification enables these particles to be compatible with most media. This allows using water-soluble light-absorbing agents in hydrophobic solvents or matrix.

In addition, nanoparticles can be considered as a standardization agent: whatever the light absorbing agent encapsulated, the external surface of nanoparticle interacting with the monomer can be the same, thus enabling the easy introduction of a given light-absorbing agent in a formulation if a similar substrate has already been introduced in a formulation, even with a different light-absorbing additive.

### DETAILED DESCRIPTION

In a preferred embodiment, the mineral oxide comprised in the nanoparticles is a transparent material. In particular, the mineral oxide is preferably selected from the group comprising silicon dioxide (SiO₂), titanium oxide (TiO₂), zirconium oxide (ZrO₂) and mixtures thereof. Among these oxides, silicon dioxide is particularly preferred.

According to a preferred embodiment, the nanoparticles have a homogeneous composition from inside to outside in which the light absorbing agent is uniformly distributed. This feature allows an acute control on the optical properties of the overall nanoparticles. According to this feature, the light-absorbing agent is encapsulated in nanoparticles, i.e. the light-absorbing agent is contained within or grafted on said nanoparticles.

In another embodiment, the nanoparticles have a core containing the light-absorbing additive and a shell surrounding the core. The shell is preferably chosen so as to isolate the core from the matrix. As such, the nature of the shell will preferably be linked to the matrix in which the corresponding particle is meant to be used.

Nanoparticles behave like reservoirs, in which light-absorbing agents are stored and protected. Light-absorbing agents may be homogenously dispersed in nanoparticles or localized in the core of nanoparticles. Light-absorbing agents may also be localized at the surface or inside the porosity of nanoparticles.

Indeed, active reactants from the lens composition according to the invention, i.e. radicals involved in radical polymerization, will not be able to diffuse in the internal part of nanoparticles. If light-absorbing additives are located on the surface or in porosity of nanoparticles, active reactants may reach them, but as mobility of grafted or trapped additives is hindered, probability of reaction is lowered and additives are also protected.

The refractive index of the nanoparticles is preferably from 1.47 to 1.74, as measured according to the ISO 489:1999. More preferably the refractive index of the nanoparticles is identical to the refractive index of the polymer matrix. Indeed, the closer both refractive indices are, the lesser the impact of the nanoparticles on the overall transmission of the lens composition.

The refractive index of mineral-based nanoparticles depends on the type of mineral oxide or mixture of mineral oxides that is used to prepare the nanoparticle. As such, the refractive index of a SiO₂ nanoparticle is 1.47-1.5 and the refractive index of a nanoparticle comprising a mixture of SiO₂ and TiO₂, a mixture of SiO₂ and ZrO₂, or a mixture of SiO₂ and Al₂O₃ can reach 1.56 or 1.6.

According to the invention, the light absorbing agent LA is chosen from a colorant, such a dye or a pigment, which can have several aggregation levels.

In the sense of the present invention, the light absorbing agent LA absorbs light in the visible range, from 380 nm to 780 nm. The light absorbing agent may also have a maximum of absorption in Ultra Violet range, below 380 nm, but still having a significant absorption in visible range. The light absorbing agent may also have a maximum of absorption in Near Infra Red range, above 780 nm, but still having a significant absorption in visible range. Preferably maxima of absorption of the light absorbing agent LA are included in the visible range.

In the sense of the present invention, a colorant which has several aggregation levels is a colorant which can be either in monomeric form (LA_{M}), or in the form of aggregates (LA_{A}) of at least two monomers stacked together by mean of intermolecular interactions, in particular via Pi-stacking (also called π-π stacking).

Preferably, the light absorbing agent LA_{A} is an aggregate of at least 2 light absorbing agents LA_{M}.

The absorbance ratio A of the light absorbing agent LA comprised in the composite material of the nanoparticles is the ratio of the absorbance of LA measured at the wavelength of maximum absorption of LA_{A} and A_{M} is absorbance of LA measured at the wavelength of maximum absorption of LA_{M}. This ratio directly reflects the respective proportions of monomeric form and aggregated form of the light absorbing agent LA comprised in the composite material of the nanoparticles.

According to the invention, the absorbance measurement protocol consists in dispersing 0.03 wt. % of dried nanoparticles in a solvent, in particular in the liquid raw monomer used for the preparation of an ophthalmic lens, such as CR-39, and measuring absorbance with a UV-Vis spectrophotometer (Cary), with reference to a blank made of solvent without particles in a 2 mm thick cuvette. As mentioned above, two absorbance measurements are made, one at the wavelength of maximum absorption of LA_{A} to get A_{A} and one at the wavelength of maximum absorption of LA_{M} to get A_{M}.

The light absorbing agent LA is preferably selected from the group comprising, phenazines, phenoxazines, phenothiazine, porphyrins, and mixtures thereof. Among these particular light absorbing agents, blue dyes such as for example methylene blue and Nile blue are particularly preferred.

According to a particular and preferred embodiment of the present invention, the mineral oxide of the matrix is SiO₂ and the light absorbing agent LA is methylene blue.

The absorbance ratio A of the light absorbing agent LA preferably ranges from about 1.3 to 5.

The amount of the light absorbing agent LA preferably ranges from about 0.001 to about 10 wt. %, and more preferably from about 0.1 to about 3 wt. %, relative to the total weight of said nanoparticles.

In the context of the present invention, the term “nanoparticles” is intended to mean individualized particles of any shape having a size, measured in its longest direction, in the range of about 1 nm to about 10 μm, preferably in the range of about 5 nm to about 5000 nm, and even more preferably from about 100 to about 200 nm, as measured by the Dynamic Light Scattering method disclosed herein.

The nanoparticles according to the present invention preferably have a spherical form.

A second object of the present invention is a method for the preparation of nanoparticles as defined according to the first object of the present invention, wherein said method comprises at least the following steps,

i) a step of preparing nanoparticles of a composite material comprising at least one light absorbing agent in a monomeric form LA_{M} dispersed in a matrix of a mineral oxide,

ii) a step of annealing the nanoparticles obtained in step i) at a temperature ranging from 80 to 300° C. for a period of time ranging from 5 min to 120 hours.

Nanoparticles of a composite material comprising at least one light absorbing agent in a monomeric form LA_{M} dispersed in a matrix of a mineral oxide of step i) can be prepared by several methods well known in the art, in particular, by Stöber synthesis or reverse microemulsion.

As a first example, when the mineral oxide is silicon dioxide, silica nanoparticles can be prepared by Stöber synthesis by mixing silicon dioxide precursor, such as tetraethyl orthosilicate, and the light-absorbing agent in an excess of water containing a low molar-mass alcohol such as ethanol and ammonia. In the Stöber approach, the light-absorbing agent may be functionalized so as to be able to establish a covalent link with silica, for example silylated with a conventional silane, preferably an alkoxysilane. Stöber synthesis advantageously yields monodisperse SiO₂ particles of controllable size.

As a second example, nanoparticles containing a light-absorbing agent can also be prepared by reverse (water-in-oil) microemulsion by mixing an oil phase, such as cyclohexane and n-hexanol; water; a surfactant such as Triton X-100; a light absorbing agent, one or more mineral oxide precursors such as tetraethyl orthosilicate and titanium alkoxylate; and a pH adjusting agent such as sodium hydroxide. In the reverse micro-emulsion approach, a larger quantity of polar light-absorbing agent can be encapsulated in the mineral oxide matrix than those encapsulated with the Stöber synthesis: the encapsulation yield can be very high, thus avoiding the waste of expensive light-absorbing agent. Moreover, this method advantageously allows an easy control of particle size, especially in the case of reverse microemulsions. Additionally, this method enables the addition of TiO₂ or ZrO₂ in the silica nanoparticles.

Nanoparticles obtained by Stöber synthesis and reverse (water-in-oil) microemulsion are highly reticulated and coated with hydrophobic silica groups thus preventing leakage of the light-adsorbing agent out of the nanoparticles and preventing the migration of a radical inside the nanoparticles during polymerization of the lens.

Nanoparticles obtained by the above-detailed method can be directly engaged into step ii), or firstly pre-treated to reduce their size, for example with a grinding step.

According to a preferred embodiment of the present invention, the step of annealing is carried out at a temperature ranging from 80 to 180° C. for 30 min to 24 hours.

The annealing step ii) can be performed for example in an air oven.

The annealing step ii) can be carried only once or alternatively at least 2 times or more to adjust the light absorbance ratio A if necessary. In that case, the method according to the invention can comprise a further step iii) of measuring the absorbance ratio A of said nanoparticules to determine if said ratio has the desired value or not and if a further step ii) of annealing is needed or not.

In particular, thanks to the annealing step of the method according to the invention, a single dye material encapsulated in a matrix of mineral oxide can lead to several hues within a given interval depending on the process condition, i.e. the temperature and duration of the annealing step, thus, enabling the use of the same basic material for different product applications. In particular, the annealing step is performed to modulate the aggregation levels of the light absorbing agent that are responsible for the final color of the nanoparticles.

Therefore, a third object of the present invention is the use of the method defined according to the second object of the present invention to modify the hue of nanoparticles of a composite material comprising at least one light absorbing agent LA dispersed in a matrix of a mineral oxide.

The nanoparticles defined according the first object of the present invention can advantageously be used to balance the intrinsic and undesired natural color of polymers used to manufacture ophthalmic lens, in particular to balance the yellow color.

The yellowness index (YI) of the cured ophthalmic lens can be calculated from tristimulus values (X, Y, Z) according to ASTM D-1925 standard, through the relation: YI=(128 X−106 Z)/Y.

A forth object of the present invention is thus an ophthalmic lens comprising nanoparticles as defined according to the first object of the present invention or prepared according to the second object of the present invention.

The ophthalmic lens of the invention comprises a polymer matrix and nanoparticles which are dispersed therein.

The polymer matrix is obtained by polymerization of a polymerizable liquid composition comprising monomer or oligomer in presence of a catalyst for initiating the polymerization of said monomer or oligomer.

The polymer matrix and the nanoparticles dispersed therein thus form together a composite substrate, i.e. a composite material having two main surfaces corresponding in the final ophthalmic lens to the front and rear faces thereof.

In one embodiment, the ophthalmic lens consists essentially in the polymer matrix and the nanoparticles dispersed therein.

In another embodiment, the ophthalmic lens comprises an optical substrate on which a coating of the polymer matrix and the nanoparticles dispersed therein is deposited.

The polymer matrix is preferably a transparent matrix.

The polymer matrix can be advantageously chosen from a thermoplastic resin, such as a polyamide, polyimide, polysulfone, polycarbonate, polyethylene terephthalate, poly(methyl(meth)acrylate), cellulose triacetate or copolymers thereof, or is chosen from a thermosetting resin, such as a cyclic olefin copolymer, a homopolymer or copolymer of allyl esters, a homopolymer or copolymer of allyl carbonates of linear or branched aliphatic or aromatic polyols, a homopolymer or copolymer of (meth)acrylic acid and esters thereof, a homopolymer or copolymer of thio(meth)acrylic acid and esters thereof, a homopolymer or copolymer of urethane and thiourethane, a homopolymer or copolymer of epoxy, a homopolymer or copolymer of sulphide, a homopolymer or copolymer of disulphide, a homopolymer or copolymer of episulfide, a homopolymer or copolymer of thiol and isocyanate, and combinations thereof.

The amount of said nanoparticles in the polymer matrix can be ≤1000 ppm, preferably, ≤ than 250 ppm.

The polymerizable liquid composition used for generating the aforesaid polymer matrix—hereinafter referred to as “the polymerizable composition”—comprises a monomer or oligomer, a catalyst, and nanoparticles containing a light-absorbing additive as defined according to the first object of the present invention. Said monomer or oligomer can be either an allyl or a non-allyl compound.

The monomer or oligomer can in particular be an allyl monomer or an allyl oligomer, i.e. the monomer or the oligomer included in the polymerizable composition according to the present invention is a compound comprising an allyl group.

Examples of suitable allyl compounds include diethylene glycol bis(allyl carbonate), ethylene glycol bis(allyl carbonate), oligomers of diethylene glycol bis(allyl carbonate), oligomers of ethylene glycol bis(allyl carbonate), bisphenol A bis(allyl carbonate), diallylphthalates such as diallyl phthalate, diallyl isophthalate and diallyl terephthalate, and mixtures thereof.

The monomer or the oligomer included in the polymerizable composition according to the present invention can also be chosen among non-allyl monomers or oligomers. Examples of suitable non-allyl compounds include thermosetting materials known as acrylic monomers having acrylic or methacrylic groups. (Meth)acrylates may be monofunctional (meth)acrylates or multifunctional (meth)acrylates bearing from 2 to 6 (meth)acrylic groups or mixtures thereof. Without limitation, (meth)acrylate monomers are selected from:

alkyl (meth)acrylates, in particular (meth)acrylates derived from adamantine, norbornene, isobornene, cyclopentadiene or dicyclopentadiene; C₁-C₄ alkyl (meth)acrylates such as methyl (meth)acrylate and ethyl (meth)acrylate;

aromatic (meth)acrylates such as benzyl (meth)acrylate, phenoxy (meth)acrylates or fluorene (meth)acrylates;

(meth)acrylates derived from bisphenol, especially bisphenol-A;

polyalkoxylated aromatic (meth)acrylates such as polyethoxylated bisphenolate di(meth)acrylates, polyethoxylated phenol (meth)acrylates;

polythio(meth)acrylates;

product of esterification of alkyl (meth)acrylic acids with polyols or epoxies; and

mixtures thereof.

(Meth)acrylates may be further functionalized, especially with halogen substituents, epoxy, thioepoxy, hydroxyl, thiol, sulphide, carbonate, urethane or isocyanate function.

Other examples of suitable non-allyl compounds include thermosetting materials used to prepare polyurethane or polythiourethane matrix, i.e. mixture of monomer or oligomer having at least two isocyanate functions with monomer or oligomer having at least two alcohol, thiol or epithio functions.

Monomer or oligomer having at least two isocyanate functions may be selected from symmetric aromatic diisocyanates such as 2,2′ Methylene diphenyl diisocyanate (2,2′ MDI), 4,4′ dibenzyl diisocyanate (4,4′ DBDI), 2,6 toluene diisocyanate (2,6 TDI), xylylene diisocyanate (XDI), 4,4′ Methylene diphenyl diisocyanate (4,4′ MDI) or asymmetric aromatic diisocyanates such as 2,4′ Methylene diphenyl diisocyanate (2,4′ MDI), 2,4′ dibenzyl diisocyanate (2,4′ DBDI), 2,4 toluene diisocyanate (2,4 TDI) or alicyclic diisocyanates such as Isophorone diisocyanate (IPDI), 2,5(or 2,6)-bis(iso-cyanatomethyl)-Bicyclo[2.2.1]heptane (NDI) or 4,4′ Diisocyanato-methylenedicyclohexane (H12MDI) or aliphatic diisocyanates such as hexamethylene diisocyanate (HDI) or mixtures thereof.

Monomer or oligomer having at least two thiol functions may be selected from Pentaerythritol tetrakis mercaptopropionate, Pentaerythritol tetrakis mercaptoacetate, 4-Mercaptomethyl-3,6-dithia-1,8-octanedithiol, 4-mercaptomethyl-1,8-dimercapto-3,6-dithiaoctane, 2,5-d imercaptomethyl-1,4-dithiane, 2,5-bis[(2-mercaptoethyl)thiomethyl]-1,4-dithiane, 4,8-d imercaptomethyl-1,11-dimercapto-3,6,9-trithiaundecane, 4,7-d imercaptomethyl-1,11-dimercapto-3,6,9-trithiaudecane, 5,7-dimercaptomethyl-1,11-dimercapto-3,6,9-trithiaundecane and mixture thereof.

Monomer or oligomer having at least two epithio functions may be selected from bis(2,3-epithiopropyl)sulfide, bis(2,3-epithiopropyl)disulfide, bis[4-(beta-epithiopropylthio)phenyl]sulfide and bis[4-(beta-epithiopropyloxy)cyclohexyl]sulfide.

The polymerizable liquid composition used for generating the aforesaid matrix comprises:

a) at least one monomer or oligomer,

b) at least one catalyst for initiating the polymerization of said monomer or oligomer,

c) nanoparticles of a composite material comprising at least one light absorbing agent LA dispersed in a matrix of a mineral oxide as defined according to the first object of the present invention, said nanoparticles being dispersed in said monomer or oligomer.

If the monomer or oligomer is of allyl type, the amount of said allyl monomer or oligomer in the polymerizable composition used for generating the polymer matrix according to the present invention may be from 20 to 99% by weight, in particular from 50 to 99% by weight, more particularly from 80 to 98% by weight, even more particularly from 90 to 97% by weight, based on the total weight of the composition. In particular, the polymerizable composition used for generating the polymer matrix may comprise from 20 to 99% by weight, in particular 50 to 99% by weight, more particularly from 80 to 98% by weight, even more particularly from 90 to 97% by weight, based on the total weight of the composition, of diethylene glycol bis(allyl carbonate), oligomers of diethylene glycol bis(allyl carbonate) or mixtures thereof.

According to a particular embodiment, the catalyst is diisopropyl peroxydicarbonate (IPP).

The amount of catalyst in the polymerizable composition according to the present invention may be from 1.0 to 5.0% by weight, in particular from 2.5 to 4.5% by weight, more particularly from 3.0 to 4.0% by weight, based on the total weight of the composition.

The polymerizable composition used for generating the polymer matrix may also comprise a second monomer or oligomer that is capable of polymerizing with the allyl monomer or oligomer described above. Examples of a suitable second monomer include: aromatic vinyl compounds such as styrene, [alpha]-methylstyrene, vinyltoluene, chlorostyrene, chloromethylstyrene and divinylbenzene; alkyl mono(meth)acrylates such as methyl (meth)acrylate, n-butyl (meth)acrylate, n-hexyl (meth)acrylate, cyclohexyl (meth)acrylate, 2-ethylhexyl (meth)acrylate, methoxydiethylene glycol (meth)acrylate, methoxypolyethylene glycol (meth)acrylate, 3-chloro-2-hydroxypropyl (meth)acrylate, stearyl (meth)acrylate, lauryl (meth)acrylate, phenyl (meth)acrylate, glycidyl (meth)acrylate and benzyl (meth)acrylate, 2-hyd roxyethyl (meth)acrylate, 2-hydroxypropyl (meth)acrylate, 3-hydroxypropyl (meth)acrylate, 3-phenoxy-2-hydroxypropyl (meth)acrylate and 4-hydroxybutyl (meth)acrylate; di(meth)acrylates such as ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, neopentyl glycol di(meth)acrylate, polypropylene glycol di(meth)acrylate, 2-hydroxy-1,3-di(meth)acryloxypropane, 2,2-bis[4-((meth)acryloxyethoxy)phenyl]propane, 2,2-bis[4-((meth)acryloxydiethoxy)phenyl]propane and 2,2-bis[4-((meth)-acryloxypolyethoxy)phenyl]propane; tri(meth)acrylates such as trimethylolpropane tri(meth)acrylate and tetramethylolmethane tri(meth)acrylate; tetra(meth)acrylates such as tetramethylolmethane tetra(meth)acrylate. These monomers may be used singly or in combination of two or more. In the above description, “(meth)acrylate” means “methacrylate” or “acrylate”, and “(meth)acryloxy” means “methacryloxy” or “acryloxy”.

The amount of the second monomer or oligomer in the polymerizable composition used for generating the polymer matrix according to the present invention may be from 1 to 80% by weight, in particular from 1 to 50% by weight, more particularly from 2 to 20% by weight, even more particularly from 3 to 10% by weight, based on the total weight of the composition.

If the monomer or oligomer is of (meth)acrylic type, the amount of said (meth)acrylic monomer or oligomer in the polymerizable composition used for generating the polymer matrix according to the present invention is from 20 to 99%, in particular from 50 to 99% by weight, more particularly from 80 to 98%, even more particularly from 90 to 97% by weight, based on the total weight of the composition.

Examples of monomer of (meth)acrylic are alkyl mono(meth)acrylates, di(meth)acrylates, tri(meth)acrylates or tetra(meth)acrylates, as defined above. These monomers may be used singly or in combination of two or more.

The polymerizable composition used for generating the polymer matrix may also comprise a second monomer or oligomer that is capable of polymerizing with the (meth)acrylic monomer or oligomer described above.

Examples of a suitable second monomer include: aromatic vinyl compounds such as styrene. These monomers may be used singly or in combination of two or more.

The amount of the second monomer or oligomer in the polymerizable composition used for generating the matrix according to the present invention may be from 1 to 80% by weight, in particular from 1 to 50% by weight, more particularly from 2 to 20% by weight, even more particularly from 3 to 10% by weight, based on the total weight of the composition.

If the polymer matrix according to the invention is of polyurethane or polythiourethane type, the monomer or oligomer having at least two isocyanate functions and monomer or oligomer having at least two alcohol, thiol or epithio functions are preferably selected in a stoichiometric ratio, so as to obtain a complete reaction of all polymerizable functions.

The catalyst included in the polymerizable liquid composition according to the present invention is a catalyst that is suitable for initiating the monomer polymerization, such as for example an organic peroxide, an organic azo compound, an organotin compound, and mixtures thereof.

Examples of a suitable organic peroxide include dialkyl peroxides, such as diisopropyl peroxide and di-t-butyl peroxide; ketone peroxides such as methyl ethyl ketone peroxide, methyl isopropyl ketone peroxide, acetylacetone peroxide, methyl isobutyl ketone peroxide and cyclohexane peroxide; peroxydicarbonates such as diisopropyl peroxydicarbonate, bis(4-t-butylcyclohexyl) peroxydicarbonate, di-sec-butyl peroxydicarbonate and isopropyl-sec-butylperoxydicarbonate; peroxyesters such as t-butyl peroxy-2-ethylhexanoate and t-hexyl peroxy-2-ethylhexanoate; diacyl peroxides such as benzoyl peroxide, acetyl peroxide and lauroyl peroxide; peroxyketals such as 2,2-d i(tert-butylperoxy)butane, 1,1-d i(tert-butylperoxy)cyclohexane and 1,1-bis(tert-butylperoxy)3,3,5-trimethylcyclohexane; and mixtures thereof.

Examples of a suitable organic azo compound include 2,2′-azobisisobutyronitrile, dimethyl 2,2′-azobis(2-methylpropionate), 2,2′-azobis(2-methylbutyronitrile), 2,2′-azobis(2,4-d imethylvaleronitrile), 4,4′-azobis(4-cyanopentanoic acid), and mixtures thereof.

Examples of a suitable organotin compound are dimethyltin chloride, dibutyltin chloride, and mixtures thereof.

The process carried out for preparing the ophthalmic lens according to the invention, comprises the steps of:

a) providing monomers or oligomers from which the polymer matrix can be prepared;

b) preparing nanoparticles encapsulating a light-absorbing agent according to the method as defined in the second object of the present invention, either in the form of a powder which is dispersible within the monomers or oligomers or in the form of a dispersion of nanoparticles in a liquid which is dispersible within the monomers or oligomers;

c) providing a catalyst for initiating the polymerization of said monomers or oligomers;

d) mixing the monomers or oligomers, the nanoparticles and the catalyst so as to obtain a polymerizable liquid composition in which nanoparticles are dispersed;

e) optionally depositing the polymerizable liquid composition on a substrate;

f) curing the polymerizable liquid composition.

Preferably, the curing is a thermal curing.

As used herein, a coating that is said to be deposited on a surface of a substrate is defined as a coating, which (i) is positioned above the substrate, (ii) is not necessarily in contact with the substrate, that is to say one or more intermediate layers may be arranged between the substrate and the layer in question, and (iii) does not necessarily completely cover the substrate.

A coating may be deposited or formed through various methods, including wet processing, gaseous processing, and film transfer.

According to a preferred embodiment, the polymerizable liquid composition may be stirred until homogeneous and subsequently degassed and/or filtered before curing.

According to a preferred embodiment, when nanoparticles are provided in the form of a dispersion in a liquid, wherein the dispersing liquid is dispersible within monomer or oligomer, in particular, the dispersing liquid is the monomer or oligomer used for generating the matrix according to the invention.

The polymerizable liquid composition described above may be cast into a casting mold for forming a lens and polymerized by heating at a temperature of from 40 to 130° C., in particular from 75 ° C. to 105 ° C. or in particular from 100 ° C. to 150 ° C. or in particular from 45 to 95° C. According to a preferred embodiment, the heating may last for 5 to 24 hours, preferably 7 to 22 hours, more preferably 15 to 20 hours.

The casting mold may then be disassembled and the lens may be cleaned with water, ethanol or isopropanol.

The ophthalmic lens may then be coated with one or more functional coatings selected from the group consisting of an anti-abrasion coating, an anti-reflection coating, an antifouling coating, an antistatic coating, an anti-fog coating, a polarizing coating, a tinted coating and a photochromic coating.

The light-absorbing agent LA that is contained in nanoparticles dispersed in the composition is as already defined above.

The ophthalmic lens according to the invention is a lens which is designed to fit a spectacles frame so as to protect the eye and/or correct the sight and can be an uncorrective (also called plano or afocal lens) or corrective ophthalmic lens.

Corrective lens may be a unifocal, a bifocal, a trifocal or a progressive lens.

The invention will now be described in more detail with the following examples which are given for purely illustrative purposes and which are not intended to limit the scope of the invention in any manner.

### EXAMPLES

Figures

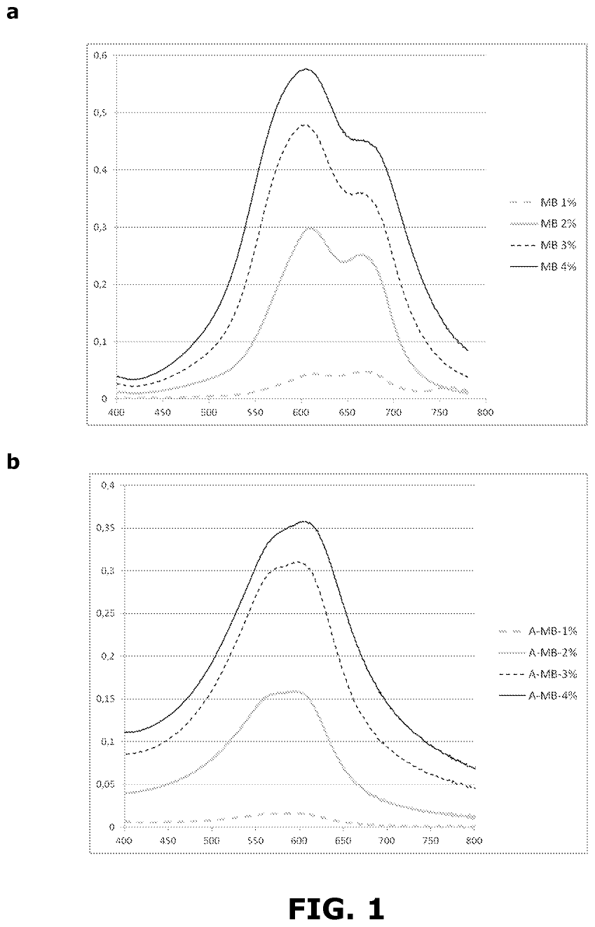

FIG. 1a is a graph representing the absorption spectra of nanoparticles obtained by the Stöber method and measured before the annealing step (0.03 wt. % of nanoparticles in CR-39©) comprising different concentration of methylene blue as a function of Wavelength (nm). On this figure, the grey dotted line corresponds to nanoparticles prepared with a methylene blue solution at 1% w/w, the grey solid line corresponds to nanoparticles prepared with a methylene blue solution at 2% w/w, the black dotted line corresponds to nanoparticles prepared with a methylene blue solution at 3% w/w, and the black solid line corresponds to nanoparticles prepared with a methylene blue solution at 4% w/w. The experimental protocol is detailed in example 1 below.

FIG. 1b is a graph representing the absorption spectra of nanoparticles from FIG. 1a, but measured after annealing at 180° C. for 2 hours.

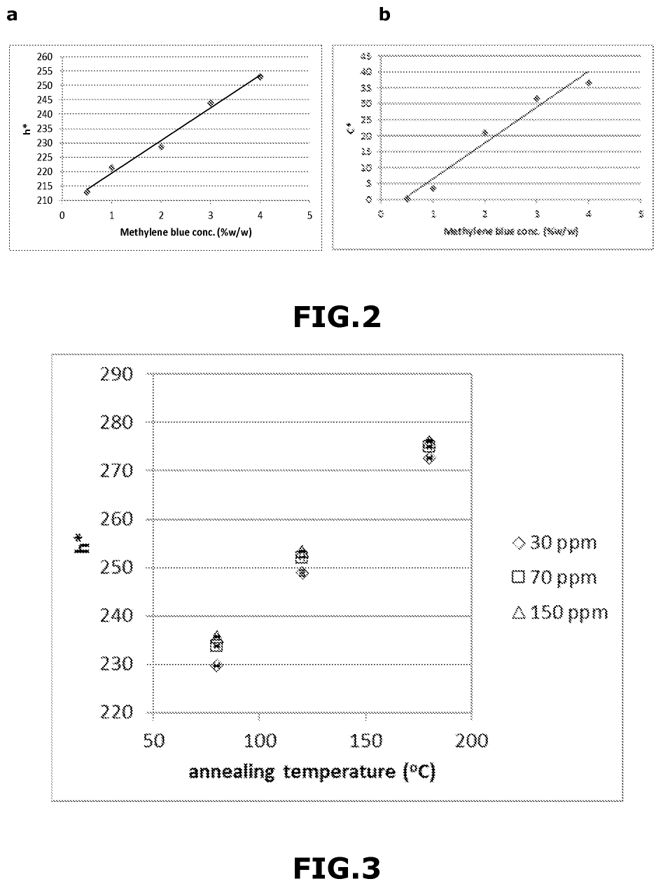

FIG. 2 gives the graphs representing the correlation of h* (FIG. 2a) and C* (FIG. 2b) with silica nanoparticles prepared by the Stöber method with methylene blue solutions at 0.5, 1, 2, 3 or 4 wt %. On these graphs, h*, respectively C* (in absolute value) is a function of methylene blue concentration (in % w/w).

FIG. 3 gives the results of the effects of the annealing temperature (° C.) of nanoparticles on the hue (h*) of clear lenses comprising silica nanoparticles obtained by the Stöber method and prepared with a methylene blue solution at 2% w/w. On this figure, diamonds correspond to 30 ppm of nanoparticles in lenses, squares correspond to 70 ppm of nanoparticles in lenses and triangles correspond to 150 ppm nanoparticles in lenses.

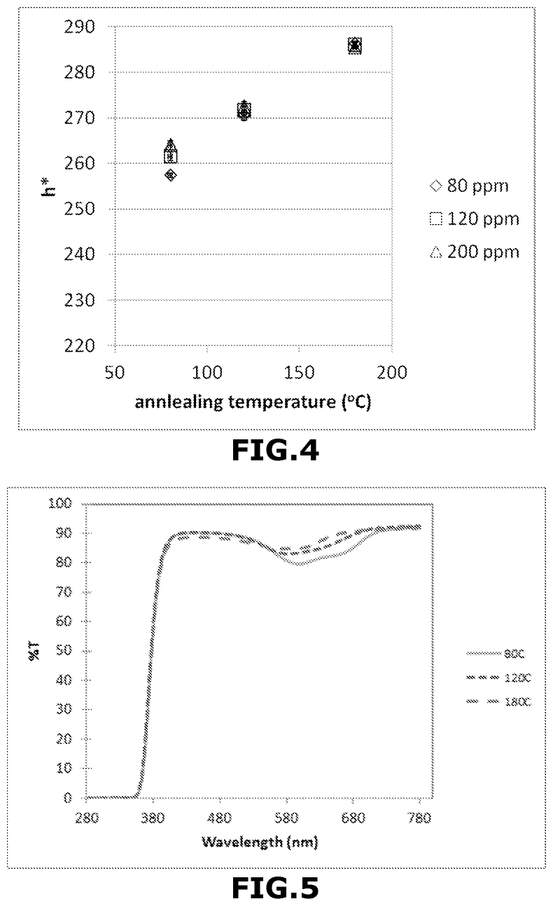

FIG. 4 gives the results of the effects of the annealing temperature (° C.) of nanoparticles on the hue (h*) of clear lenses comprising silica nanoparticles obtained by the reverse emulsion method and prepared with a 2% w/w solution of methylene blue. On this figure, diamonds correspond to 80 ppm of nanoparticles in lenses, squares correspond to 120 ppm of nanoparticles in lenses and triangles correspond to 200 ppm of nanoparticles in lenses.

FIG. 5 is the transmission spectra from lenses comprising 70 ppm of silica nanoparticles obtained by the Stöber method, prepared with a methylene blue solution at 2% w/w. and at different annealing temperatures (lenses represented by squares in FIG. 3). On this figure, the transmittance (% T) is a function of the wavelength (in nm) and the grey solid curve corresponds to annealing at 80° C. for 2 hours, the curve in close-up lines corresponds to annealing at 120° C. for 2 hours and the curve in spaced lines corresponds to annealing at 180° C. for 2 hours.

Materials

Chemicals used in the following examples are listed in Table 1 below:

TABLE 1

| Component | CAS Number | Function |
|---|---|---|
| CR-39 ® | 142-22-3 | allyl monomer |
| CR-39E ® | Proprietary | allyl monomer |
| | | (as disclosed in |
| | | U.S. Pat. No. |
| | | 7,214,754) |
| IPP | 105-64-6 | catalyst |
| UV-9 | 000131-53-3 | UV Absorber |
| | | (benzophenone) |
| Ammonium hydroxide | 1336-21-6 | Reagent |
| solution (30%) | | |
| Deionized Water (dH₂O) | — | Solvent |
| Tetraethyl orthosilicate | 78-10-4 | Silica precursor |
| (TEOS) | | |
| Methylene blue | 7720-79-3 | Light absorbing agent |
| Methanol | 67-56-1 | Solvent |
| Triton ® X100 | 9002-93-1 | Nonionic surfactant |
| n-Hexanol | 111-27-3 | Solvent |
| Cyclohexane | 110-82-7 | Solvent |

Characterizations

Measure of the absorbance of nanoparticles: The absorbance measurement protocol consists in dispersing 0.03 wt. % of dried nanoparticles in CR-39, and measuring absorbance with a UV-Vis spectrophotometer (Cary), with reference to a blank made of CR-39 without particles in a 2 mm thick cuvette.

Color of nanoparticles: Colorimetric parameters of the nanoparticles of the invention are measured according to the international colorimetric system CIE L*a*b*, i.e. calculated between 380 and 780 nm, taking the standard illuminant D 65 at angle of incidence 15° and the observer into account (angle of 10°). 0.03% of dried particles are dispersed in CR-39 and transmitted light through such material (in a 2 mm thick cuvette) is measured (with comparison to blank). Colorimetric parameters of this transmitted light are computed, yielding hue (h*) and chroma (C*) of nanoparticles.

Color of lenses: Color of lenses are measured according to the same principle as for nanoparticles, but on 2 mm thick lenses at center. Transmitted light of lenses comprising nanoparticles is measured and compared to the lens obtained with same polymerizable composition but without particles. Colorimetric parameters of this transmitted light are computed, yielding hue (h*) and chroma (C*).

Size of nanoparticles: The size of the nanoparticles is measured by standard Dynamic Light Scattering method. The technique measures the time-dependent fluctuations in the intensity of scattered light from a suspension of nanoparticles undergoing random Brownian motion. Analysis of these intensity fluctuations allows for the determination of the diffusion coefficients, which, using the Stokes-Einstein relationship can be expressed as the particle size.

### Example 1

### Preparation of Nanoparticles According to the Invention By the Stöber Method

Preparation:

In this example silica nanoparticles comprising methylene blue as light absorbing agent were prepared by the Stöber method.

24 mL of methanol, 6 mL of ammonium hydroxide solution (30%), 0.4 mL of Methylene blue solutions (respectively at 1, 2, 3 and 4% w/w) and TEOS (0.2 mL) were mixed for 2 hours at a speed of about 800 rpm. After reaction finished, the nanoparticles were collected by centrifugation and washed with methanol. The nanoparticles were then dried at room temperature until a constant weight was attained. The nanoparticles were then annealed at 80, 120 or 180° C. for 2 hours.

These nanoparticles can thereafter be used for the manufacture of ophthalmic lenses after dispersion at 0.3 wt. % in CR-39 (masterbatch).

Characterization

The effects of the concentration of methylene blue contained in silica nanoparticles on their color have been determined by measuring the absorbance of the nanoparticles measured before performing annealing step (i.e. nanoparticules dried at ambient temperature) and after performing the annealing step à 180° C. for 2 hours.

The absorption spectra of 0.03 wt. % nanoparticles in CR-39 as a function of Wavelength (nm), measured before performing the annealing step, is represented on FIG. 1a annexed. On this figure, the grey dotted line corresponds to nanoparticles prepared with a methylene blue solution at 1% w/w, the grey solid line corresponds to nanoparticles prepared with a methylene blue solution at 2% w/w, the black dotted line corresponds to nanoparticles prepared with a methylene blue solution at 3% w/w, and the black solid line corresponds to nanoparticles prepared with a methylene blue solution at 4% w/w.

As it can be seen on FIG. 1a, the variation of methylene blue concentration in nanoparticles varied the color of encapsulated material. Absorption peak of methylene blue show different dimer/monomer ratio. At high concentration of methylene blue solution, big dimer peak at 608 nm is dominant while monomer peak at 670 nm arises after lowering concentration of methylene blue solution.

FIG. 1b shows the absorption spectra of the same particles, after annealing at 180° C. for 2 hours. These results show that the absorbance of monomeric form of methylene blue (above 650 nm) has almost disappeared. Methylene blue is present in form of agglomerates predominantly after such annealing step.

FIG. 2 gives the graphs representing the correlation of h* (FIG. 2a) and C* (FIG. 2b) with nanoparticles prepared with methylene solutions at 0.5, 1, 2, 3 or 4 wt %. On these graphs, h*, respectively C* (in absolute value) is a function of methylene blue concentration (in % w/w).

These results show that C* increases with methylene blue concentration, and more interesting h* roughly linearly increases with methylene blue concentration too. These results demonstrate that a change in light absorbing agent content in nanoparticle mineral oxide matrix makes it possible to finely adjust the actual hue of the light absorbing agent to reach optimum color, rather than just increasing intensity (C*) of a color at a given hue. This effect can be attributed to dimerization that occurs increasingly when methylene blue is encapsulated in higher concentration in the particles.

### Example 2

### Preparation of Nanoparticles According to the Invention By the Reverse Emulsion Method

Preparation

In this example silica nanoparticles comprising methylene blue as light absorbing agent were prepared by the reverse emulsion method.

In 100 ml Duran bottle, 7.56 g of Triton X-100, 5.86 g of n-hexanol, and 23.46 g of cyclohexane were mixed by magnetic stirrer at a speed of 400 rpm for 15 min. After that, 1.6 ml demineralized water was added dropwise, and stirring was continued for a further 15 min. 0.32 ml of methylene blue solution (2% w/w) were added dropwise. Stirring was continued for 15 min, 0.4 ml of TEOS were then added dropwise and stirring continued for 15 min. Last addition was ammonium hydroxide 30% w/w, dropwise 0.24 ml and the mixture was stirred at a speed of 400 rpm for 24 h. Then 50 ml of acetone was added and the nanoparticles were collected by centrifugation, washed with acetone and dried at room temperature. The nanoparticles were then annealed at 80, 120 or 180° C. for 2 hours.

These nanoparticles can thereafter be used for the manufacture of ophthalmic lenses after dispersion at 0.3 wt. % in CR-39 (masterbatch).

### Example 3

### Preparation of Ophthalmic Lenses Comprising Silica Nanoparticules Comprising a Light Absorbing Agent

Masterbatches (MB) of nanoparticules (NP) prepared according to example 1 with the methylene blue solution at 2% w/w and example 2 above (also obtained with a methylene blue solution at 2% w/w) were used to prepare ophthalmic lenses.

Monomer Formulations

Different monomer formulations (MF) were prepared. Their compositions (in wt. %) are detailed in Table 2 below:

TABLE 2

| | Annealing | | | NP of | NP of | | |
|---|---|---|---|---|---|---|---|
| | temp. | | | Ex. 1 | Ex. 2 | | |
| MF | (° C.) | CR-39 | CR-39E | (MB) | (MB) | UV-9 | IPP |
| 1 | 80 | 94.03 | 2.00 | 1.00 | — | 0.05 | 2.92 |
| 2 | 80 | 92.70 | 2.00 | 2.33 | — | 0.05 | 2.92 |
| 3 | 80 | 90.03 | 2.00 | 5.00 | — | 0.05 | 2.92 |
| 4 | 120 | 94.03 | 2.00 | 1.00 | — | 0.05 | 2.92 |
| 5 | 120 | 92.70 | 2.00 | 2.33 | — | 0.05 | 2.92 |
| 6 | 120 | 90.03 | 2.00 | 5.00 | — | 0.05 | 2.92 |
| 7 | 180 | 94.03 | 2.00 | 1.00 | — | 0.05 | 2.92 |
| 8 | 180 | 92.70 | 2.00 | 2.33 | — | 0.05 | 2.92 |
| 9 | 180 | 90.03 | 2.00 | 5.00 | — | 0.05 | 2.92 |
| 10 | 80 | 92.36 | 2.00 | — | 2.67 | 0.05 | 2.92 |
| 11 | 80 | 91.03 | 2.00 | — | 4.00 | 0.05 | 2.92 |
| 12 | 80 | 88.36 | 2.00 | — | 6.67 | 0.05 | 2.92 |
| 13 | 120 | 92.36 | 2.00 | — | 2.67 | 0.05 | 2.92 |
| 14 | 120 | 91.03 | 2.00 | — | 4.00 | 0.05 | 2.92 |
| 15 | 120 | 88.36 | 2.00 | — | 6.67 | 0.05 | 2.92 |
| 16 | 180 | 92.36 | 2.00 | — | 2.67 | 0.05 | 2.92 |
| 17 | 180 | 91.03 | 2.00 | — | 4.00 | 0.05 | 2.92 |
| 18 | 180 | 88.36 | 2.00 | — | 6.67 | 0.05 | 2.92 |

Each monomer formulation was prepared by weighing and mixing the different ingredients in a beaker. CR-39, CR-39E and masterbatch containing nanoparticles were first mixed. Once homogeneous, UV9 was added and then the beaker content was mixed again until full dissolution. Finally, IPP was added and the mixture was stirred thoroughly, then degassed and filtered.

Lens Manufacturing

Each monomer formulation was used to prepare ophthalmic lenses according to a casting and polymerization process.

Plano glass molds were filled with each monomer formulations using a cleaned syringe, and the polymerization was carried out in a regulated oven in which the temperature was gradually increased from 45 to 85° C. in 15 hours and maintained at 85° C. during 2 hours. The molds were then disassembled and the resulting lenses had a 2 mm thickness at their center.

Characterization

FIG. 3 gives the results of the effects of the annealing temperature (° C.) of nanoparticles on the hue (h*) of clear lenses comprising silica nanoparticles obtained by the Stöber method and prepared with a methylene blue solution at 2% w/w. On this figure, diamonds correspond to 30 ppm of nanoparticles in lenses (MF1, MF4 and MF7), squares correspond to 70 ppm of nanoparticles in lenses (MF2, MF5 and MF8) and triangles correspond to 150 ppm nanoparticles in lenses (MF3, MF6 and MF9).

These results show that increasing annealing temperature leads to increasing in h*.

FIG. 4 gives the results of the effects of the annealing temperature (° C.) of nanoparticles on the hue (h*) of clear lenses comprising silica nanoparticles obtained by the reverse emulsion method and prepared with a 2% w/w solution of methylene blue. On this figure, diamonds correspond to 80 ppm of nanoparticles in lenses (MF10, MF13 and MF16), squares correspond to 120 ppm of nanoparticles in lenses (MF11, MF14 and MF17) and triangles correspond to 200 ppm of nanoparticles in lenses (MF12, MF15 and MF18).

These results show that increasing annealing temperature leads to increasing in h*.

FIG. 5 is the transmission spectra from lenses comprising 70 ppm of silica nanoparticles obtained by the Stöber method, prepared with a methylene blue solution at 2% w/w. and at different annealing temperatures (lenses represented by squares in FIG. 3, MF2, MF5 and MF8). On this figure, the transmittance (% T) is a function of the wavelength (in nm) and the grey solid curve corresponds to annealing at 80° C. for 2 hours, the curve in close-up lines corresponds to annealing at 120° C. for 2 hours and the curve in spaced lines corresponds to annealing at 180° C. for 2 hours.

These results show that adding nanoparticles obtained after performing io the annealing step at a temperature of 80° C. brings the transmission downward.

Moreover, varying annealing temperature enhances changing in absorption spectra which leads to change of color tones of lenses.

This example illustrates that lenses comprising a light absorbing agent encapsulated in a mineral oxide matrix can be adjusted to get the optimum color. The color generated can be modified by selecting a type of encapsulation method, adding various amounts of light absorbing agent at synthesis steps and varying the annealing temperature. The color is then stable during the lens fabrication process.

1. Nanoparticles of a composite material comprising at least one light absorbing agent LA dispersed in a matrix of a mineral oxide, wherein:
the light absorbing agent LA is dispersed in said matrix in both a monomeric form LAₘ and an aggregated form LA_{A},
said light absorbing agent LA has an absorbance ratio A=A_{A}/A_{M} ranging from 1.25 to 10, where A_{A} is absorbance of LA measured at the wavelength of maximum absorption of LA_{A} and A_{M} is absorbance of LA measured at the wavelength of maximum absorption of LA_{M}.

2. The nanoparticles of claim 1, wherein the mineral oxide is selected from the group comprising silicon dioxide, titanium oxide and zirconium oxide.

3. The nanoparticles of claim 1, wherein the light absorbing agent LA_{A} is an aggregate of at least 2 light absorbing agents LA_{M}.

4. The nanoparticles according to claim 1, wherein said light absorbing agent LA is selected from the group comprising, phenazines, phenoxazines, phenothiazine, porphyrins, and mixtures thereof.

5. The nanoparticles according to claim 4, wherein said light absorbing agent LA is a blue light absorbing agent selected from the group comprising methylene blue and Nile blue.

6. The nanoparticles according to claim 1, wherein the mineral oxide of the matrix is SiO₂ and the light absorbing agent LA is methylene blue.

7. The nanoparticles according to claim 1, wherein said absorbance ratio A ranges from 1.3 to 5.

8. The nanoparticles according to claim 1, wherein said nanoparticles have a mean size ranging from 5 nm to 5000 nm.

9. The nanoparticles according to claim 1, wherein the amount of said absorbing agent ranges from 0.001 to 10 wt. %, relative to the total weight of said nanoparticles.

10. A method for the preparation of nanoparticles as defined in claim 1, wherein said method comprises at least the following steps,
i) a step of preparing nanoparticles of a composite material comprising at least one light absorbing agent in a monomeric form LA_{M} dispersed in a matrix of a mineral oxide,
ii) a step of annealing the nanoparticles obtained in step i) at a temperature ranging from 80 to 300° C. for a period of time ranging from 5 min to 120 hours.

11. The method of claim 10, wherein the step of annealing is carried out at a temperature ranging from 80 to 180° C. for 30 min to 24 hours.

12. The use of the method as defined in claim 10, further defined as a method of modifying a hue of nanoparticules of a composite material comprising at least one light absorbing agent LA dispersed in a matrix of a mineral oxide.

13. An ophthalmic lens comprising nanoparticles as defined in claim 1.

14. The ophthalmic lens of claim 13, wherein said nanoparticles are dispersed in a polymer matrix.

15. The ophthalmic lens of claim 14, wherein the amount of said nanoparticles in the polymer matrix is ≤1000 ppm.

16. The ophthalmic lens of claim 15, wherein the amount of said nanoparticles in the polymer matrix is ≤ than 250 ppm.

17. The nanoparticles according to claim 8, wherein said nanoparticles have a mean size ranging from 100 to 200 nm.

18. The nanoparticles according to claim 9, wherein the amount of said absorbing agent ranges from 0.1 to 3 wt. %, relative to the total weight of said nanoparticles.
